(19) United States
(12) Patent Application Publication
(10) Pub. No.: US 2008/0189848 A1
(43) Pub. Date: Aug. 14, 2008

(54) Foot soak tray having massage device

(75) Inventor: Chien Hsin Chao, Changhua Hsien (TW)

Correspondence Address: CHARLES E. BAXLEY, ESQUIRE, 90 JOHN STREET, SUITE 309, NEW YORK, NY, 10038, US

(73) Assignee: Fwu Yeow Enterprise Co., Ltd.

(21) Appl. No.: 11/344,671

(22) Filed: Jan. 31, 2006

(51) Int. Cl. A61H 33/02; A47K 3/022; A61H 1/00; A61H 15/00; A61H 9/00

(52) U.S. Cl. 4/545; 4/622; 601/22; 601/115; 601/158

(57) ABSTRACT

A foot soak tray includes a base housing, a container disposed above the base housing and having a space for receiving water in the space of the container, and a heating device disposed in the chamber of the base housing for heating the water received in the space of the container. A reflector may be disposed below the heating device for reflecting a heat generated by the heating device. A massage device may be disposed in the container and includes one or more rotatable rollers having a number of protrusions for massaging the feet of the user. The massage device preferably includes a length shorter than that of the container for forming an opening between the container and the massage device.

### BACKGROUND OF THE INVENTION

1. Field of the Invention

The present invention relates to a foot soak tray, and more particularly to a foot soak tray having a heater for heating the water contained in the foot soak tray and having a massage device for massaging the feet of the users.

2. Description of the Prior Art

Typical foot soak trays comprise a container or receptacle for receiving water and for hydrotherapeutic purposes, and having a serrated surface or one or more bulges extended or provided in the container or receptacle for being engaged with the feet of the users and for massaging the feet of the users.

For example, U.S. Design Pat. No. Des. 247,511 to Lee et al., and U.S. Design Pat. No. Des. 322,320 to Cohn disclose two of the typical foot soak trays each also comprising a container or receptacle for receiving water and one or more bulges extended or provided in the container or receptacle for massaging the feet of the users.

However, the typical foot soak trays have no heating devices for heating the water contained in the container or receptacle such that the water may become cold after use.

In addition, the typical foot soak trays have no movable or rotatable massage devices for massaging the feet of the users, such that the users have to massage their feet before or after conducting the hydrotherapeutic operations with the other or additional massage devices.

The present invention has arisen to mitigate and/or obviate the afore-described disadvantages of the conventional foot soak tray devices.

### SUMMARY OF THE INVENTION

The primary objective of the present invention is to provide a foot soak tray including a heater for heating the water contained in the foot soak tray and for maintaining the water in a suitable warm temperature.

The other objective of the present invention is to provide a foot soak tray including a massage device for massaging the feet of the users and for allowing the user to enjoy either or both the hydrotherapeutic operations and the foot massaging operations with the single foot soak tray.

In accordance with one aspect of the invention, there is provided a foot soak tray comprising a base housing including a chamber formed therein, a container disposed above the base housing and including a space formed therein for receiving water in the space of the container, and a heating device disposed in the chamber of the base housing for heating the water received in the space of the container and for maintaining the water in the suitable or worm temperature. A medical solution may further be provided and mixed into the water.

A reflector is further disposed in the chamber of the base housing and disposed below the heating device for reflecting a heat generated by the heating device and for facilitating the heating operation to the water.

A heat insulating outer covering is attached onto the container for shielding the container and for preventing the container from being contacted by the user.

A massage device is disposed in the container and includes at least one rotatable roller having a plurality of protrusions extended therefrom for being engaged with feet of a user and for massaging the feet of the user and thus for allowing the user to enjoy either or both the hydrotherapeutic operations and the foot massaging operations with the foot soak tray.

The massage device includes a length shorter than that of the container for forming an opening between the container and the massage device. The massage device includes two walls disposed parallel to each other, and the roller is rotatably attached and supported between the walls. The massage device includes an end wall to couple the walls together.

The container includes a downwardly extending casing engaged into the base housing, and the base housing includes a plurality of anchoring members engaged between the casing and the base housing for anchoring and positioning the casing in the base housing.

A massage pad may further be disposed in the space of the container and includes a plurality of outwardly extended projections for massaging the feet of the user when the feet of the user are disengaged from the massage device.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is an exploded view of a foot soak tray in accordance with the present invention;

FIG. 2 is a perspective view of the foot soak tray;

FIG. 3 is a partial cross sectional view of the foot soak tray taken along lines 3-3 of FIG. 2;

FIGS. 4, 5, 6 are partial cross sectional views similar to FIG. 3, illustrating the operation of the foot soak tray;

FIG. 7 is a perspective view illustrating the other arrangement of the foot soak tray;

FIG. 8 is a partial exploded view of the foot soak tray as shown in FIG. 7;

FIG. 9 is a partial cross sectional view of the foot soak tray taken along lines 9-9 of FIG. 7; and

FIG. 10 is a partial cross sectional view similar to FIG. 9, illustrating the operation of the foot soak tray as shown in FIGS. 7-9.

### DETAILED DESCRIPTION OF THE PREFERRED EMBODIMENT

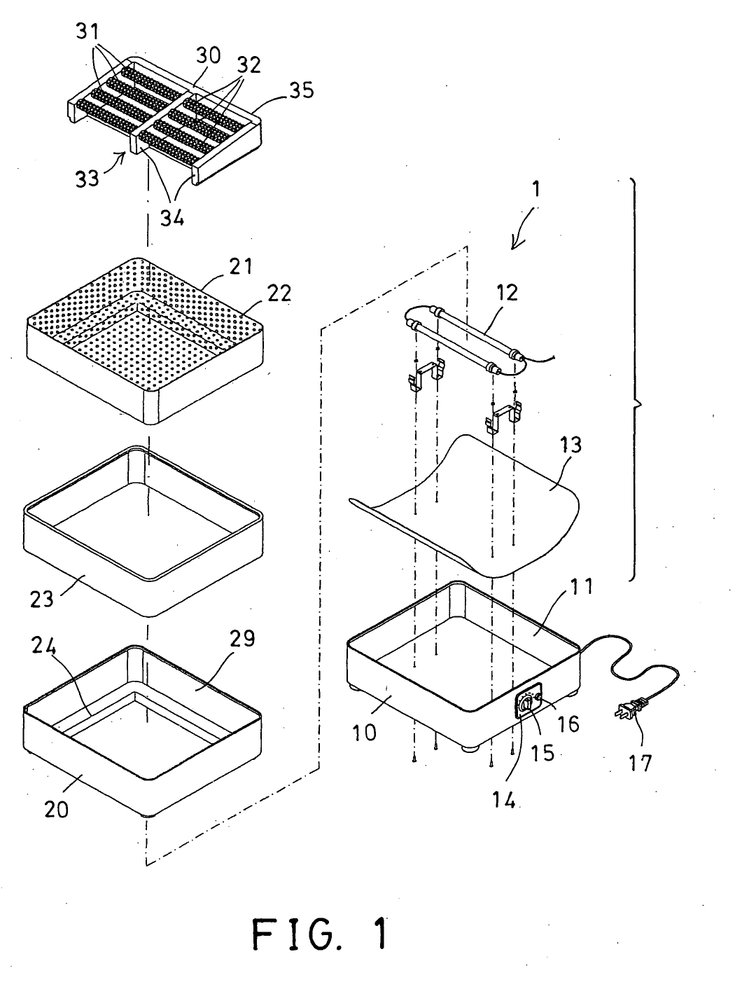

Referring to the drawings, and initially to FIGS. 1-3, a foot soak tray 1 in accordance with the present invention comprises a base housing 10 including a chamber 11 formed therein, and including one or more heating members or devices 12 disposed in the chamber 11 of the base housing 10, and including a reflector 13 also disposed in the chamber 11 of the base housing 10 and disposed below the heating devices 12 for such as reflecting and/or concentrating the heat generated by the heating devices 12 upwardly, for example.

The base housing 10 further includes a processor unit or control device 14 disposed or attached to one side portion or front portion thereof, and a knob 15 coupled to the control device 14 for controlling the heating devices 12 or for adjusting the heat generated by the heating devices 12, and a switch 16 coupled to the control device 14 for controlling or for operating the heating devices 12, and a plug or coupler 17 coupled to the control device 14 for coupling to an electric power source, such as the electric power source of the house families.

The foot soak tray 1 further includes a container 20 disposed above the base housing 10 and having a space 29 formed therein (FIG. 1) for receiving a massage member or pad 21 therein. It is preferable that the massage member or pad 21 is made of soft rubber or synthetic materials and includes a shape corresponding to that of the container 20 for being snugly disposed and engaged in the container 20, and includes a number of outwardly extended swellings or projections 22 for being engaged with the feet of the users and for massaging the feet of the users.

The container 20 is provided for receiving water and/or medical solution or the like and is provided for hydrotherapeutic purposes, and the water and/or the medical solution may be heated by the heating devices 12 and/or the heat reflected by the reflector 13 for allowing the water to be maintained in a suitable or predetermined warm temperature. It is preferable that a heat insulating outer covering 23 is further provided and attached or engaged onto the outer peripheral portion of the container 20 for shielding the container 20 and for preventing the users from contacting with the heated container 20 or for preventing the users from being hurt by the heated container 20.

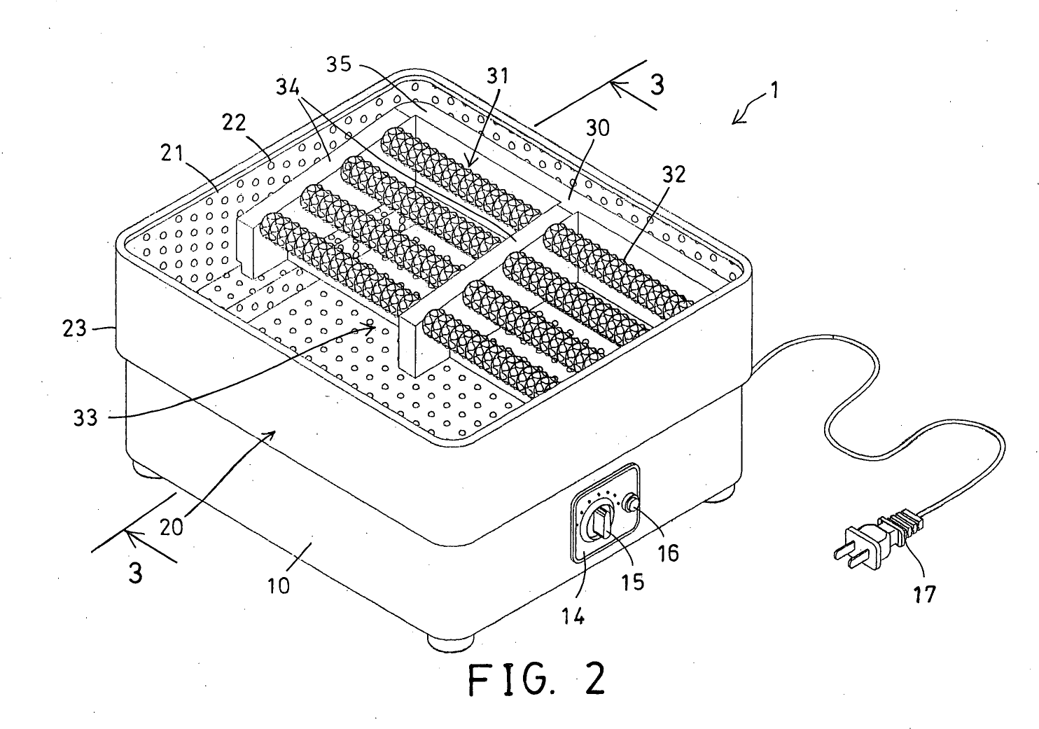

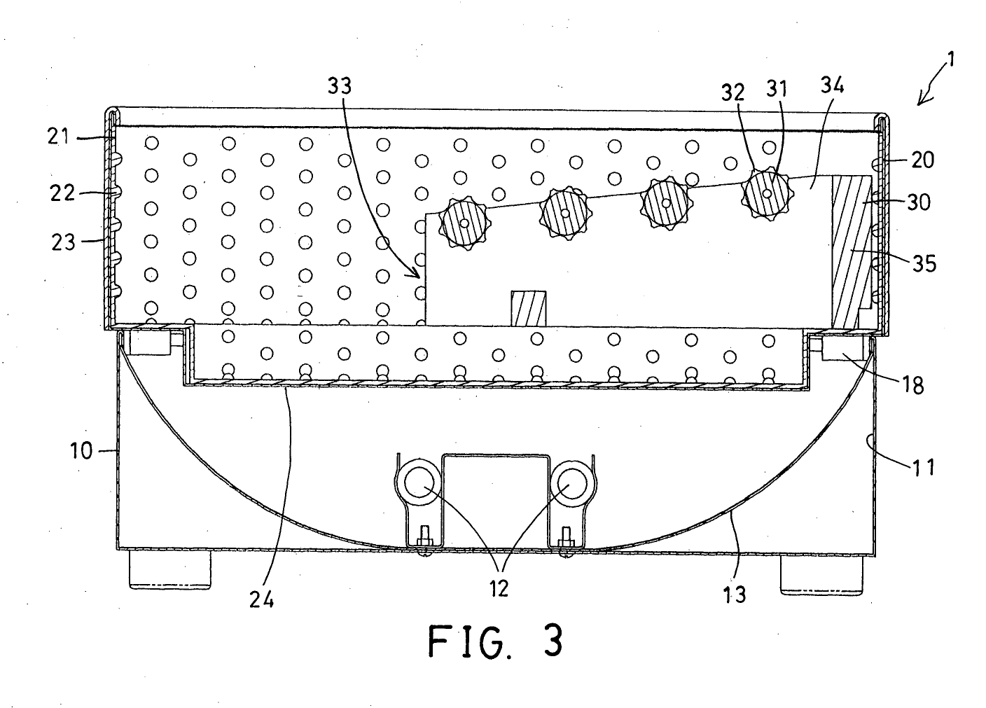

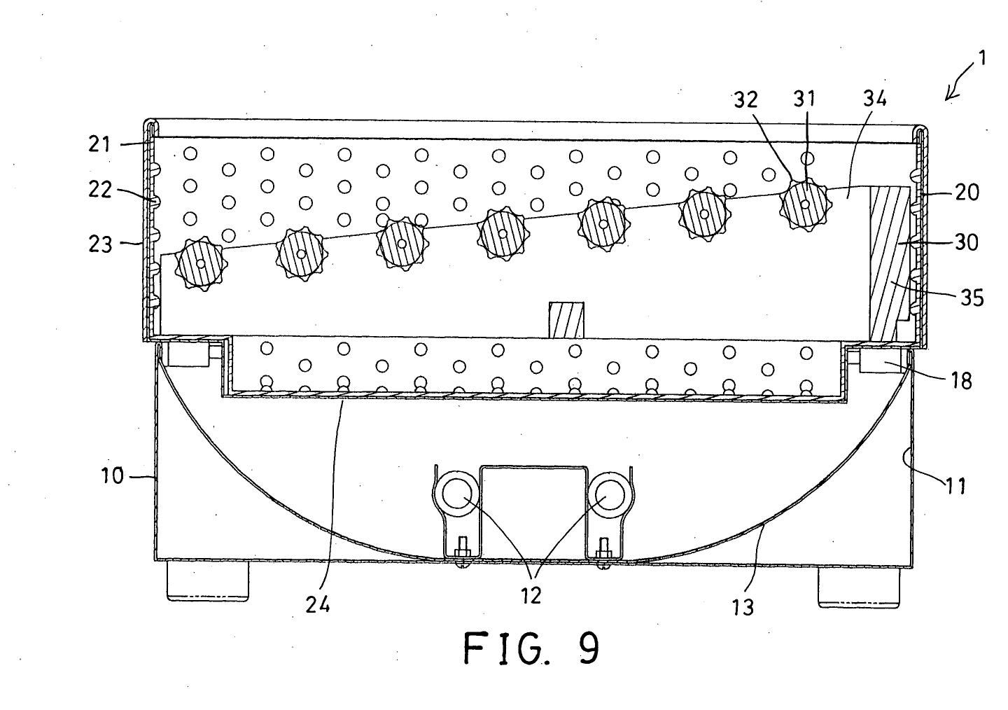

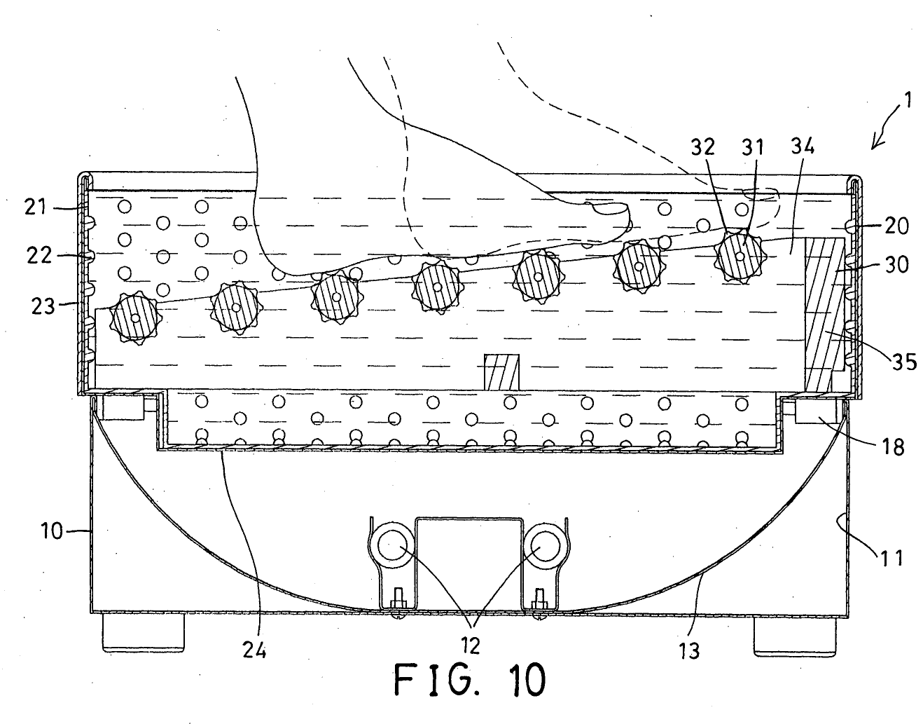

The container 20 includes a peripheral size or width or length greater than that of the base housing 10 for allowing the container 20 to be disposed above and stably supported by the base housing 10, best shown in FIGS. 2-7 and 9-10. The container 20 further includes a downwardly extending casing 24 having a size or width or length smaller than that of the base housing 10 for allowing the casing 24 to be disposed or engaged into the base housing 10. The base housing 10 further includes a number of positioning or anchoring members 18 disposed therein and engaged between the casing 24 and the base housing 10 (FIGS. 3-6, 9-10) for stably anchoring and positioning or securing the casing 24 in the base housing 10 and for stably supporting the container 20 on top of the base housing 10.

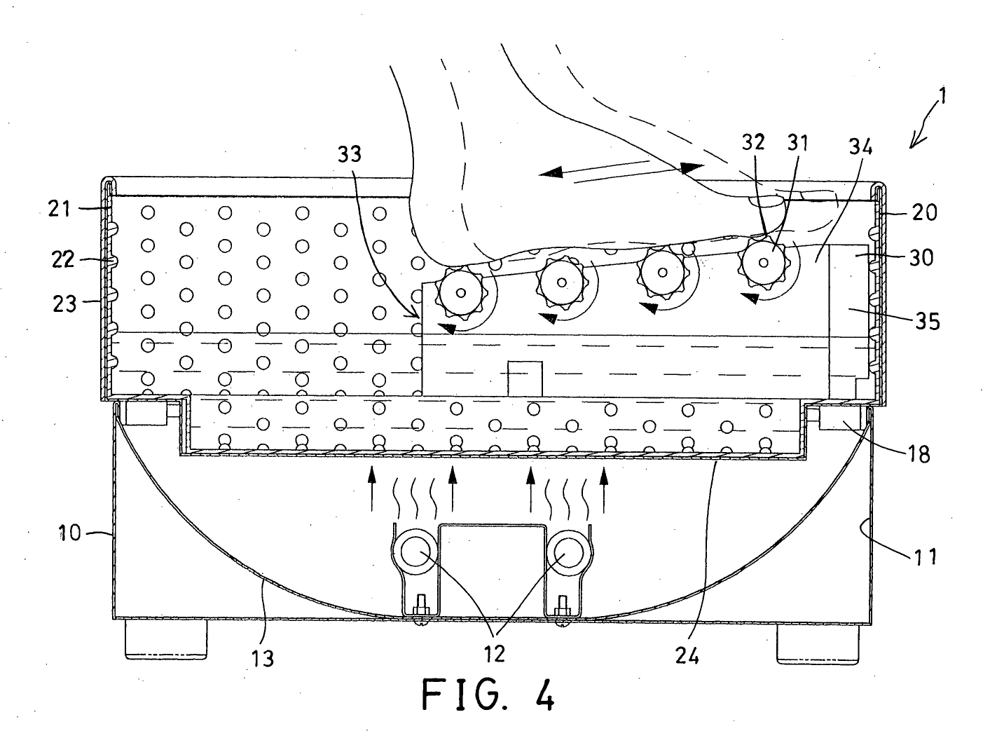

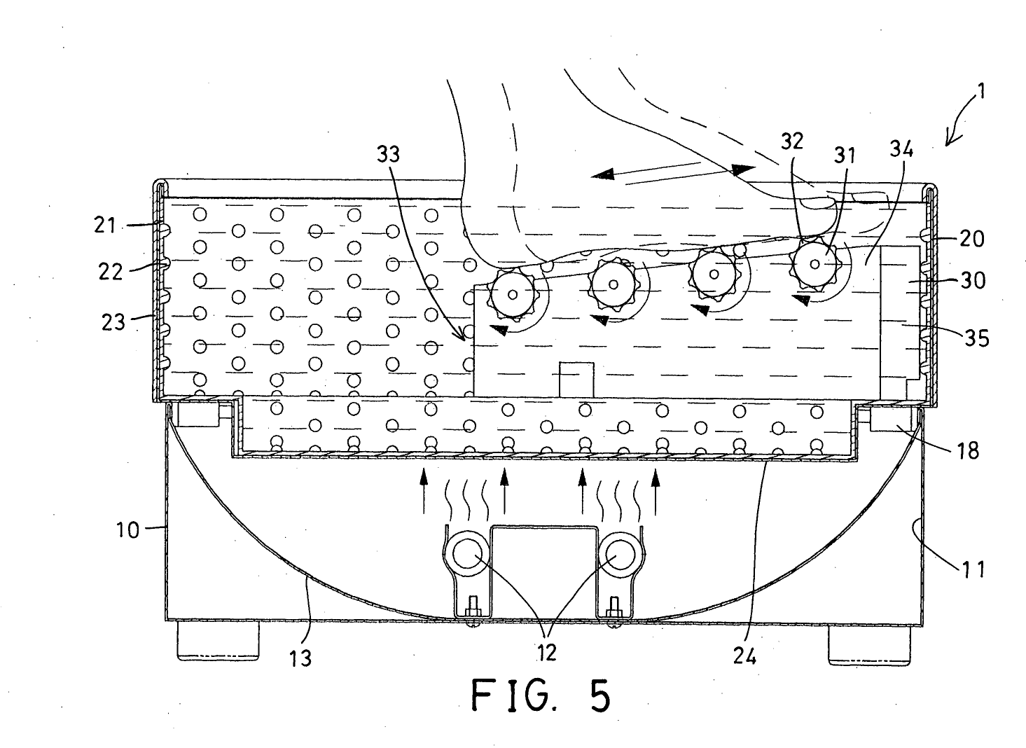

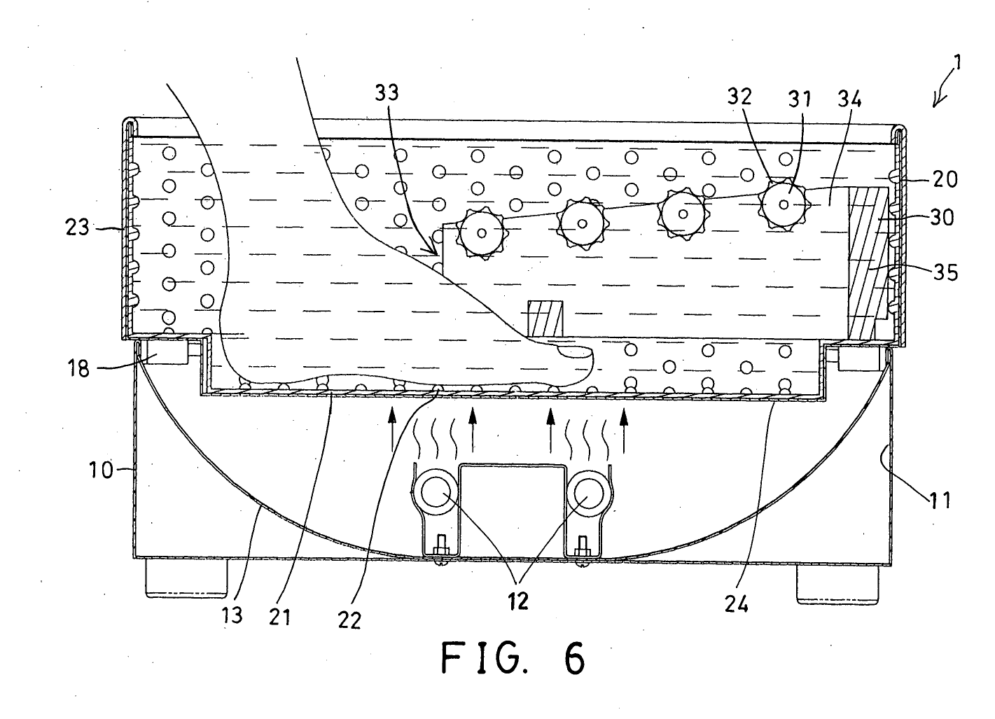

The foot soak tray 1 further includes a massage device 30 disposed in the container 20 for engaging with and for massaging the feet of the users. The massage device 30 includes one or more rotatable rollers 31 each having a number of protrusions 32 extended therefrom for being engaged with the feet of the users and for massaging the feet of the users (FIGS. 4, 5). It is preferable that the massage device 30 includes a width or length shorter than that of the container 20 for forming an opening 33 between the container 20 and the massage device 30 (FIGS. 3 and 6) and for allowing the feet to move or engage downwardly beyond the massage device 30 and to engage with the swellings or projections 22 of the massage member 21.

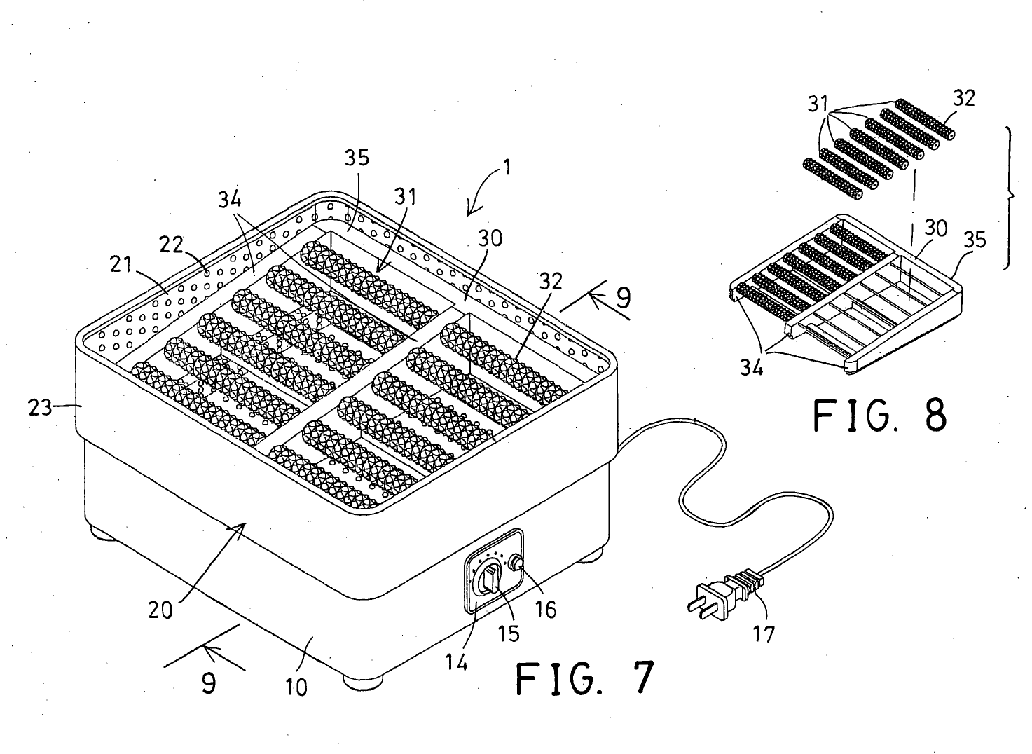

As shown in FIGS. 1 and 8, it is preferable that the massage device 30 includes two or more walls 34 disposed parallel to each other and coupled together with an end plate 35, for allowing the rollers 31 to be stably and rotatably attached and supported between the walls 34. Alternatively, as shown in FIGS. 7-10, the massage device 30 includes a width or length equals to that of the container 20 for allowing the massage device 30 to be snugly received and anchored within the container 20 (FIGS.>9, 10), and for allowing the feet to be engaged with or massaged by the massage device 30, and for preventing the feet from being engaged with the swellings or projections 22 of the massage member 21.

Accordingly, the foot soak tray in accordance with the present invention includes a heater for heating the water contained in the foot soak tray and for maintaining the water in a suitable warm temperature, and includes a massage device for massaging the feet of the users.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A foot soak tray comprising:
a base housing including a chamber formed therein,
a container disposed above said base housing and including a space formed therein for receiving water in said space of said container, and
a heating device disposed in said chamber of said base housing for heating the water received in said space of said container.

2. The foot soak tray as claimed in claim 1, wherein a reflector is disposed in said chamber of said base housing and disposed below said heating device for reflecting a heat generated by said heating device.

3. The foot soak tray as claimed in claim 1, wherein a heat insulating outer covering is attached onto said container for shielding said container and for preventing said container from being contacted by the user.

4. The foot soak tray as claimed in claim 1, wherein a massage device is disposed in said container and includes at least one rotatable roller having a plurality of protrusions extended therefrom for being engaged with feet of a user and for massaging the feet of the user.

5. The foot soak tray as claimed in claim 4, wherein said massage device includes a length shorter than that of said container for forming an opening between said container and said massage device.

6. The foot soak tray as claimed in claim 4, wherein said massage device includes two walls disposed parallel to each other, and said at least one roller is rotatably attached and supported between said walls.

7. The foot soak tray as claimed in claim 6, wherein said massage device includes an end wall to couple said walls together.

8. The foot soak tray as claimed in claim 1, wherein said container includes a downwardly extending casing engaged into said base housing, and said base housing includes a plurality of anchoring members engaged between said casing and said base housing for anchoring said casing in said base housing.

9. The foot soak tray as claimed in claim 1, wherein a massage pad is disposed in said space of said container and includes a plurality of outwardly extended projections for massaging the feet of the user.
